(19) United States
(12) Patent Application Publication
(10) Pub. No.: US 2021/0062785 A1
(43) Pub. Date: Mar. 4, 2021

(54) FOLDABLE BLADE FOR A WIND TURBINE AND METHOD OF USE

(71) Applicant: General Electric Company, Schenectady, NY (US)

(72) Inventor: Vitali Victor Lissianski, Schenectady, NY (US)

(21) Appl. No.: 16/555,047

(22) Filed: Aug. 29, 2019

(51) Int. Cl. F03D 7/02; F03D 1/06

(52) U.S. Cl. CPC F03D 7/0224; F03D 1/0633; F05B 2270/606; F05B 2270/328; F05B 2270/331; F05B 2240/21

(57) ABSTRACT

A wind turbine including a plurality of foldable rotor blades coupled to a rotatable hub. A mechanical actuation structure is coupled to the plurality of foldable rotor blades to move the plurality of foldable rotor blades to a deployed state, substantially perpendicular to the horizontal rotor axis, to capture kinetic energy from an incoming fluid flow and move the plurality of foldable rotor blades to a non-deployed state, substantially parallel to the horizontal rotor axis. The mechanical actuation structure including a plurality of toothed wheels, each coupled to one of the plurality of foldable rotor blades at a single fixed rotation point, a threaded rod disposed in cooperative engagement with each of the plurality of toothed wheels and a spring disposed proximate the threaded rod and configured to compensate for the static wind load on each of the plurality of foldable rotor blades. A method is also disclosed.

### BACKGROUND

Embodiments disclosed herein relate generally to a wind turbine including a plurality of foldable rotor blades that provide for a reduction in a static load on the rotor of the wind turbine when wind speeds exceed a rated value.

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The wind turbine may be configured as an upwind turbine, or a downwind turbine, dependent on placement of the rotor relative to the nacelle. The rotor blades capture kinetic energy of wind using known airfoil principles. The rotor blades transmit the kinetic energy in the form of rotational energy to turn a shaft coupling the rotor blades to a gearbox, or if a gearbox is not used, directly to the generator. The generator then converts the mechanical energy to electrical energy that may be deployed to a utility grid.

Rotor blades are typically precisely designed and manufactured to efficiently transfer wind energy into rotational motion, thereby providing the generator with sufficient rotational energy for power generation. Blade efficiency is generally dependent upon blade shape and surface smoothness. Unfortunately, during operation, wind turbines may encounter varying wind conditions. Rotor blades may be designed for operation in wind conditions not exceeding a rated value. Rated wind value is defined as lowest wind speed at which wind turbine produces amount of power on the turbine nameplate. As the wind conditions exceed this rated value, the wind turbine may be caused to turn at too fast a speed, causing mechanical damage to the wind turbine components, including, but not limited to the rotor blades. Damage may include bending or breaking of the blades, damage to the support tower, or the like. In addition, wind conditions may vary at the same location, making designing of the rotor blades for a specific condition inefficient.

Accordingly, there is a need for a rotor blades that is adaptable for operation in varying wind conditions. A rotor blade that can perform in a wide variety of environmental conditions would be desired.

### BRIEF SUMMARY

These and other shortcomings of the prior art are addressed by the present disclosure, which provides a foldable rotor blade for a wind turbine.

In accordance with an embodiment, provided is a wind turbine configured for extracting energy from a fluid flow. The wind turbine including a rotor comprising a rotatable hub, a plurality of foldable rotor blades coupled to the hub and a mechanical actuation structure coupled to the plurality of foldable rotor blades. The plurality of foldable rotor blades are rotatable about horizontal rotor axis. Each of the plurality of foldable rotor blades has a single fixed rotation point at a blade root. The mechanical actuation structure is coupled to the plurality of foldable rotor blades and moves the plurality of foldable rotor blades between a deployed state and a non-deployed state in response to an incoming fluid flow. The mechanical actuation structure comprises a plurality of toothed wheels, a threaded rod and a spring. Each of the plurality of foldable rotor blades is coupled to one of the plurality of toothed wheels at the single fixed rotation point. The threaded rod is disposed in cooperative engagement with each of the plurality of toothed wheels. The spring is disposed proximate the threaded rod and configured to compensate for the static wind load on each of the plurality of foldable rotor blades.

In accordance with another embodiment, provided is a wind turbine configured for extracting energy from a fluid flow. The wind turbine including a rotor comprising a rotatable hub, a plurality of foldable rotor blades and a mechanical actuation structure coupled to the plurality of foldable rotor blades. The plurality of foldable rotor blades are coupled to the hub and rotatable about a horizontal rotor axis. Each of the plurality of foldable rotor blades has a single fixed rotation point at a blade root. The mechanical actuation structure moves the plurality of foldable rotor blades to a deployed state, substantially perpendicular to the horizontal rotor axis, to capture kinetic energy from an incoming fluid flow and moves the plurality of foldable rotor blades to a non-deployed state, substantially parallel to the horizontal rotor axis. The mechanical actuation structure comprises a plurality of toothed wheels, a threaded rod and a spring. Each of the plurality of foldable rotor blades is coupled to one of the plurality of toothed wheels at the single fixed rotation point and rotatable in response to an incoming fluid flow. The threaded rod is disposed in cooperative engagement with each of the plurality of toothed wheels. The spring is disposed proximate the threaded rod and configured to compensate for the static wind load on each of the plurality of foldable rotor blades. Rotation of each of the plurality of toothed wheels applies a force on the threaded rod in a direction opposed to the incoming fluid flow and compression of the spring by the threaded rod.

In accordance with yet another embodiment, provided is a method of using of a wind turbine. The method comprises providing a wind turbine including a hub and a plurality of foldable rotor blades coupled to the hub and rotatable about a horizontal rotor axis, rotating the at least one rotor blade about its longitudinal axis to generate energy, determining if the incoming fluid flow exceeds a rated value, actuating a mechanical actuation structure coupled to each of the plurality of foldable rotor blades in the presence of an incoming fluid flow that exceeds the rated value to move the plurality of foldable rotor blades to a non-deployed state, substantially parallel to the horizontal rotor axis, determining if the incoming fluid flow exceeds the rated value, actuating the mechanical actuation structure in the presence of an incoming fluid flow that does not exceed the rated value to move the plurality of foldable rotor blades to a deployed state, substantially perpendicular to the horizontal rotor axis, to capture kinetic energy from an incoming fluid flow that is within a rated value. Each of the plurality of foldable rotor blades has a single fixed rotation point at a blade root. The mechanical actuation structure comprises a plurality of toothed wheels, a threaded rod and a spring. Each of the plurality of foldable rotor blades is coupled to one of the plurality of toothed wheels at the single fixed rotation point. The threaded rod is disposed in cooperative engagement with each of the plurality of toothed wheels. The spring is disposed proximate the threaded rod and configured to compensate for the static wind load on each of the plurality of foldable rotor blades.

Other objects and advantages of the present disclosure will become apparent upon reading the following detailed description and the appended claims with reference to the accompanying drawings.

### BRIEF DESCRIPTION OF THE FIGURES

The above and other features, aspects, and advantages of the present disclosure will become better understood when the following detailed description is read with reference to the accompanying drawings in which like characters represent like parts throughout the drawings, wherein

FIG. 1 is schematic side view of a downwind wind turbine including a plurality of foldable rotor blades in a deployed state in accordance with one or more embodiments shown or described herein;

FIG. 2 is an enlarged schematic side view of the wind turbine including the plurality of foldable rotor blades of FIG. 1 in a deployed state in accordance with one or more embodiments shown or described herein;

FIG. 3 is a schematic side view of another embodiment of a wind turbine including the plurality of foldable rotor blades in a deployed state in accordance with one or more embodiments shown or described herein;

FIG. 4 is an enlarged schematic side view of a wind turbine including a plurality of foldable rotor blades in a semi-deployed, or partially folded, state in accordance with one or more embodiments shown or described herein;

FIG. 5 is an enlarged schematic side view of a wind turbine including a plurality of foldable rotor blades in a fully retracted, or non-deployed, state in accordance with one or more embodiments shown or described herein; and

FIG. 6 is a schematic block diagram of method for operating a wind turbine in varying wind conditions in accordance with one or more embodiments shown or described herein.

### DETAILED DESCRIPTION

The invention will be described for the purposes of illustration only in connection with certain embodiments; however, it is to be understood that other objects and advantages of the present disclosure will be made apparent by the following description of the drawings according to the disclosure. While preferred embodiments are disclosed, they are not intended to be limiting. Rather, the general principles set forth herein are considered to be merely illustrative of the scope of the present disclosure and it is to be further understood that numerous changes may be made without straying from the scope of the present disclosure.

Reference will now be made in detail to the various embodiments of the invention, one or more examples of which are illustrated in the figures. Each example is provided by way of explanation of the invention, and is not meant as a limitation of the invention. For example, features illustrated or described as part of one embodiment can be used on or in conjunction with other embodiments to yield yet a further embodiment. It is intended that the present invention includes such modifications and variations.

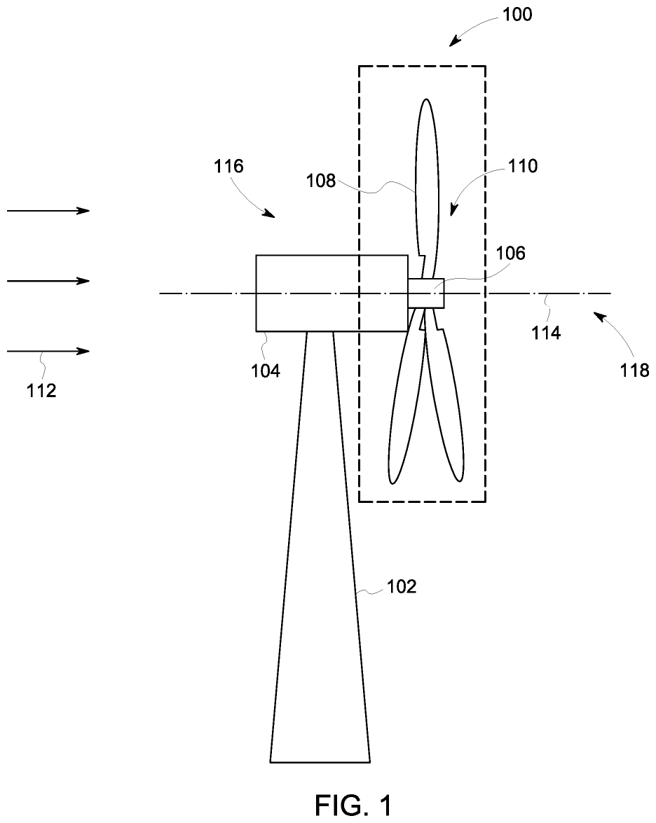

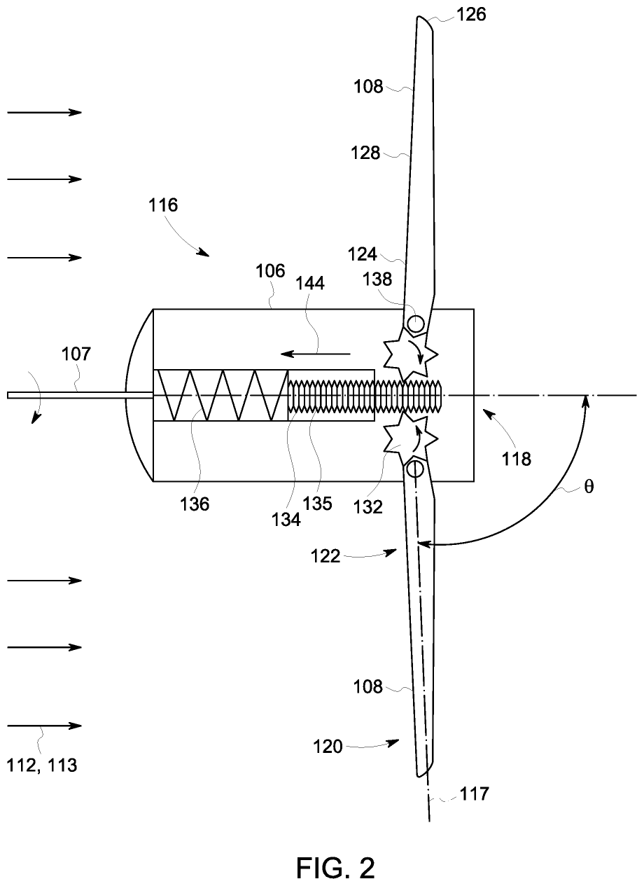

FIG. 1 shows a wind turbine 100. The wind turbine 100 includes a tower 102 onto which a nacelle 104 is arranged. Within the nacelle 104 a generator (not shown) for producing electrical current is placed. The generator is connected to a hub 106 with a substantial horizontal shaft 107 (FIGS. 2-5). A plurality of foldable rotor blades 108 are coupled to the hub 106, symmetrically disposed thereabout, and configured to rotate about a horizontal rotor axis 114 at a rate determined by the wind speed, number of blades, and the shape of the plurality of foldable rotor blades 108. The plurality of foldable blades are located downwind of the tower. The plurality of foldable rotor blades 108 are configured to extract work from an incoming prevailing fluid flow 112. Typically, the plurality of foldable rotor blades 108 includes two or more rotor blades.

The plurality of foldable rotor blades 108 may be fabricated of any suitable material including, but not limited to stretchable fabric, tensionable fabric, plastic, metal, carbon fiber and/or other construction material. In an embodiment of the plurality of foldable rotor blades 108, including an underlying support structure where included, the structure may be fabricated of any suitable material, including, but not limited to carbon fiber and/or other material capable of lending support to the plurality of foldable rotor blades.

The rotor blades 108 and the hub 106 form a rotor 110 of the wind turbine 100. In operation the incoming prevailing fluid flow 112, imparts a rotation on the rotor 110 due to an aerodynamic profile on the plurality of foldable rotor blades 108. More specifically, in the illustrated embodiment, the rotor 110 turns around the substantially horizontal rotor axis 114, which is substantially parallel to the direction of the incoming prevailing fluid flow 112. The rotor 110 drives the generator, such that electrical energy is produced from the kinetic energy of the incoming prevailing fluid flow 112.

It should be noted that relative adjectives like in front, backward, behind and rear are defined with respect to the wind direction, and more particularly the incoming prevailing fluid flow 112, related to the wind turbine 100 in operation, i.e. when the wind turbine 100 produces electrical energy. That means that the incoming prevailing fluid flow 112 flows from a front end 116 to a back end 118 of the wind turbine 100. In addition, the terms axial or radial relate to the horizontal rotor axis 114 of the hub 106, when the wind turbine 100 produces electrical energy. Thus, as described above, the horizontal rotor axis 114 is substantially parallel to the incoming prevailing fluid flow 112 direction.

Referring again to the drawings wherein, as previously stated, identical reference numerals denote the same elements throughout the various views, FIGS. 2-4 depict in simplified schematic drawings, a portion of a wind turbine, as indicated by dotted line in FIG. 1, in various states of blade deployment, generally similar to wind turbine 100 of FIG. 1, according to an embodiment. For the sake of simplicity, only a portion of the plurality of foldable rotor blades 108 is shown. Referring in general to FIGS. 2-4, each of the plurality of foldable rotor blades 108 has an outer portion 120 and an inner portion 122. The terms “outer” and “inner” are used with respect to the hub 106. Therefore, the outer portion 120 of each of the plurality of foldable rotor blades 108 is radially outside of the inner portion 122 in FIG. 2. The inner portion 122 of each of the plurality of foldable rotor blades 108 is coupled to the hub 106. Each of the plurality of foldable rotor blades 108 may be, in a typical embodiment, turned around its longitudinal axis to adjust a pitch angle. For that purpose, a pitch mechanism (not shown) is located in the hub 106 and/or the nacelle 104 of the wind turbine 100. The outer portion 120 of each of the rotor blades 108 has a wing shaped profile, such that the outer portion may also be called a profiled section or a profiled outer portion 120 of the rotor blade 108. The front end of each of the plurality of foldable rotor blades 108 is typically straight from the connection to the hub to the outer portion 120; in another typical embodiment of the present patent application the front end of each of the plurality of foldable rotor blades 108 is typically straight from a blade root 124 to a blade tip 126 of each of the plurality of foldable rotor blades 108. Thus, a leading edge 128, i.e. the windward or front edge of each of the plurality of foldable rotor blades 108, defines during operation of the wind turbine 100, i.e. when the hub 106 and the plurality of foldable rotor blades 108 turn around the horizontal rotor axis 114, a substantially flat disk.

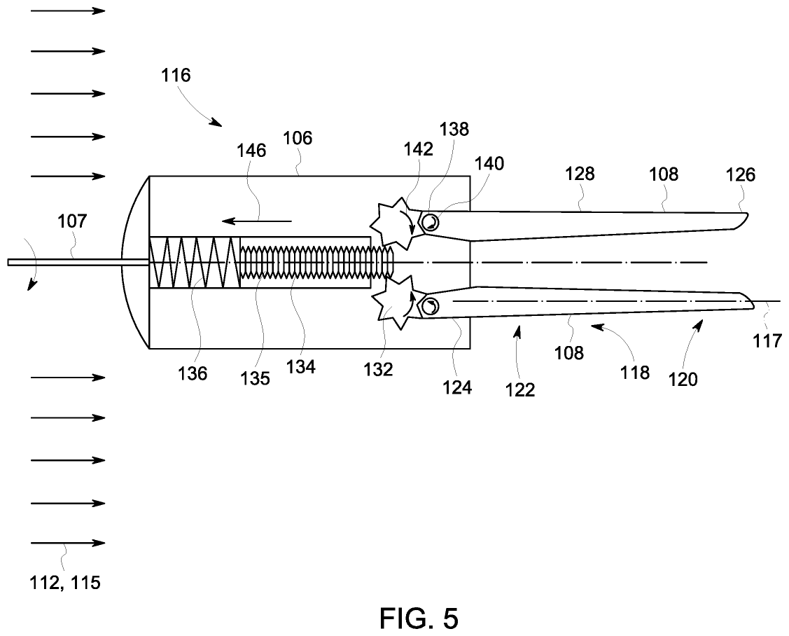

As illustrated in FIG. 2, the plurality of foldable rotor blades 108 (of which only two are illustrated) according to an embodiment are symmetrically disposed with respect to the turning axis, and more specifically, the horizontal rotor axis 114. In the illustrated embodiment, the plurality of foldable rotor blades 108 employ a mechanical actuation structure (described presently) for deployment of the plurality of foldable rotor blades 108 from a non-deployed state to a deployed state, as best illustrated in FIGS. 1 and 2, when the incoming prevailing fluid flow 112 does not exceed a rated value for the design of the plurality of rotor blades 108. More particularly, when the plurality of rotor blades 108 are subject to an incoming fluid flow that is within a rated value 113. The mechanical actuation system additionally provides for retracting of the plurality of foldable rotor blades 108 from the deployed state to a non-deployed state, as best illustrated in FIG. 5, when incoming prevailing fluid flow 112 exceeds, and more particularly, when the plurality of rotor blades 108 are subject to an incoming fluid flow that exceeds a rated value 115 and thus above the rated value for the design of the plurality of rotor blades 108. In an embodiment, a mechanical actuation structure, generally referenced 130, is comprised of a plurality of toothed wheels 132, a single threaded rod or stud 134 and a preloaded spring 136 in combination capable of deploying and retracting, or folding, the plurality of rotor blades 108 in response to the incoming prevailing fluid flow 112 as described herein, by mechanical means, and without the need for additional electronic components, or the like.

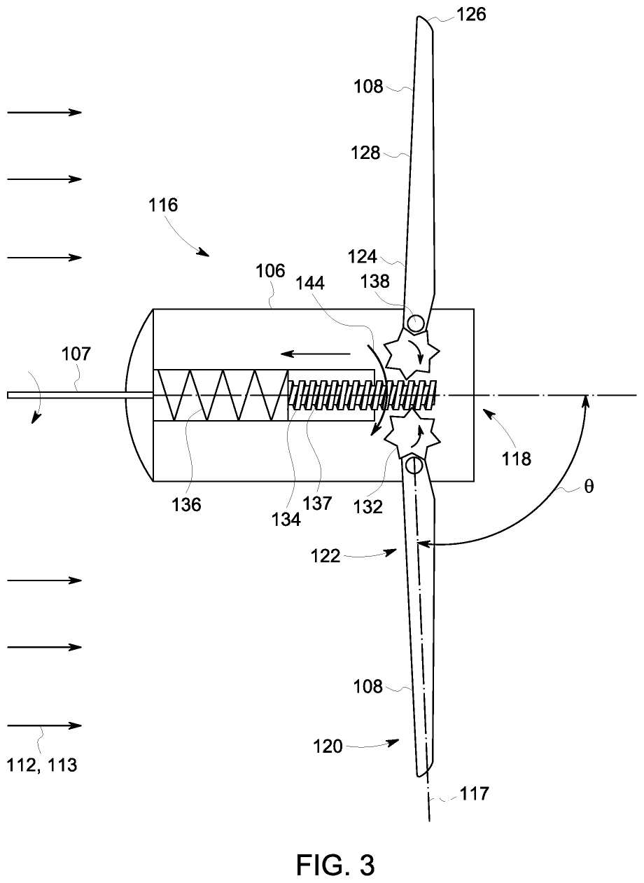

In the embodiment of FIGS. 2-5, the mechanical actuation structure 130 operates similar to a corkscrew, wherein each of the plurality of rotor blades 108 has a fixed rotation point 138 located proximate the blade root 124 and its respective toothed wheel 132. Each of the plurality of toothed wheels 132 is disposed in cooperative engagement with the threaded rod/stud 134. In an embodiment, illustrated in FIGS. 2, 4 and 5, the threaded rod/stud 134 may be configured to include a grooved surface, and more particularly, a straight threading 135, to allow the toothed wheels 132 to move the threaded rod/stud 134 horizontally/linearly, as indicated by directional arrow 144 and described presently, without rotation of the threaded rod/stud 134 when under the influence of an incoming prevailing fluid flow that is above the rated value 115. The linear movement of the threaded rod/stud 134 results in compression of the preloaded spring 136. In an alternate embodiment, as best illustrated in FIG. 3, wherein like elements are referred to with like numbers throughout the embodiments, the threaded rod/stud 134 may be configured to include a grooved surface, and more particularly, a helical threading 137, to allow the toothed wheels 132 to move the threaded rod/stud 134 horizontally/linearly, as indicated by directional arrow 144, by way of rotation of the threaded rod/stud 134, as indicated by directional arrow 146 when under the influence of an incoming prevailing fluid flow that is above the rated value 115. Similar to the embodiment of FIG. 2, the linear movement of the threaded rod/stud 134 results in compression of the preloaded spring 136.

The threaded rod/stud 134 is coupled to the preloaded spring 136 which is preloaded such that until which time the prevailing fluid flow 112 exceeds the rated value, the plurality of rotor blades 108 remain substantially perpendicular to the incoming prevailing fluid flow 112 and operational, as illustrated in FIG. 2. More specifically, the spring 136 is preloaded such that a static wind load on the rotor 110 is compensated by the preloaded spring 136.

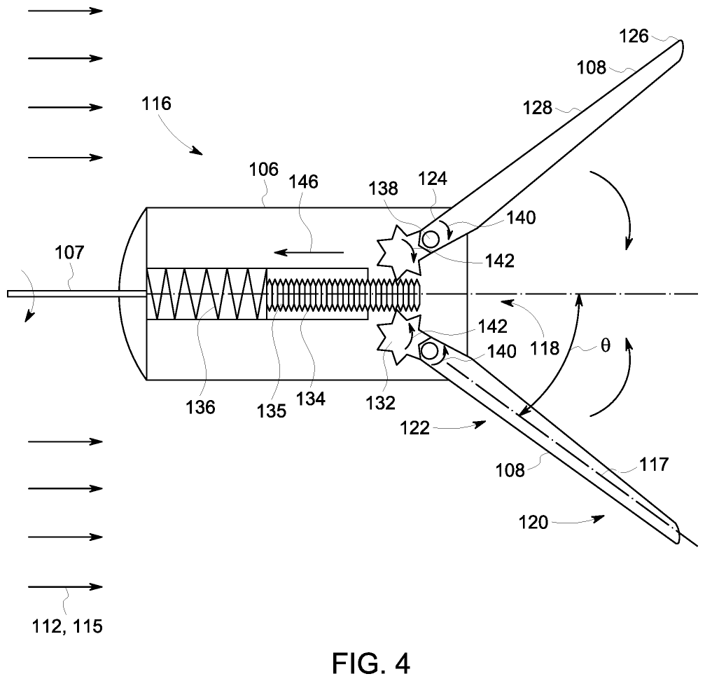

Referring now to FIG. 4, as the speed of the incoming prevailing fluid flow 112 increases above the rated value, as indicated by directional arrows 115, also referred to herein as preset parameter, the static wind load on the rotor 110 increases forcing each of the plurality of foldable rotor blades 108 to rotate about a respective fixed rotation point 138, as indicated by directional arrow 140. In response, each of the plurality of toothed wheels 132 located at a respective blade root 124 is pushed so as to force its rotation, as indicated by directional arrows 142, and move the threaded rod/stud 134 in an opposing horizontal, or linear direction in a straight line, as indicated by directional arrow 146. The linear movement of the threaded rod/stud 134 results in compression of the preloaded spring 136.

The tension of the preloaded spring 136 is selected such that when the speed of the incoming prevailing fluid flow 112 reaches the rated value, the preloaded spring 136 travels a distance equal to a quarter of a circumference of the toothed wheel 132, thereby allowing the toothed wheel 132 to rotate 90 degrees. At the end of the 90 degree toothed wheel rotation, the plurality of rotor blades 108 are folded in a manner so as to be oriented horizontally, as best illustrated in FIG. 5. In an embodiment the rated value of the incoming prevailing fluid flow 112 is approximately 14 m/s. At wind speeds of 25 m/s (cut-out speed) the plurality of foldable rotor blades 108 are fully folded in horizontal direction.

The mechanical actuation structure 130 is operable to deploy and retract any number of rotor blades, such as the plurality of rotor blades 108. Each of the plurality of rotor blades 108 is coupled to the single threaded rod/stud 134 of the mechanical actuation structure 130 with a single toothed wheel, of the plurality of toothed wheels 132. Accordingly, the degree of folding/retraction (defined as an angle θ between the horizontal rotor axis 114 and a spanwise axis 117) of each of the plurality of rotor blades 108 is always the same. This is important since non-uniformity of the plurality of rotor blades 108 will result in an unbalanced condition of the rotor 110, resulting in potential damage to the overall wind turbine 100.

The mechanical actuation structure 130 as disclosed does not require active control, in that the degree of folding/retraction of the plurality of rotor blades 108 in response to incoming prevailing fluid flow 112 is defined by the preloaded spring 136 parameters and the degree of preloading. More particularly, the mechanical actuation structure 130 provides complete mechanical automation of the blades 108.

The plurality of foldable rotor blades 108 are in a typical embodiment symmetrically placed with respect to the turning axis, and more particularly the horizontal rotor axis 114, when coupled to the wind turbine 100. When deployed as in FIGS. 1-3, the plurality of foldable rotor blades 108 guide capture the kinetic energy of the prevailing fluid flow 112 and is transformed it to electrical energy. In the illustrated embodiment, the wind turbine 100 includes three foldable rotor blades 108.

FIG. 4 illustrates in a simplified schematic the plurality of foldable rotor blades 108 during a stage of moving from a deployed state to non-deployed, or retracted, state, or vice versa. During a high wind occurrence, when loading/drag or thrust loads become too great for the plurality of foldable rotor blades 108 to withstand, and more particularly, when the plurality of foldable rotor blades 108 are subject to an incoming fluid flow that exceeds a rated value 115, the mechanical actuation structure 130 causes the plurality of rotor blades 108 to start retracting, reaching the non-deployed state at cut-out wind speed, also referred to as maximum wind, or fluid flow, speed, as shown in FIG. 5.

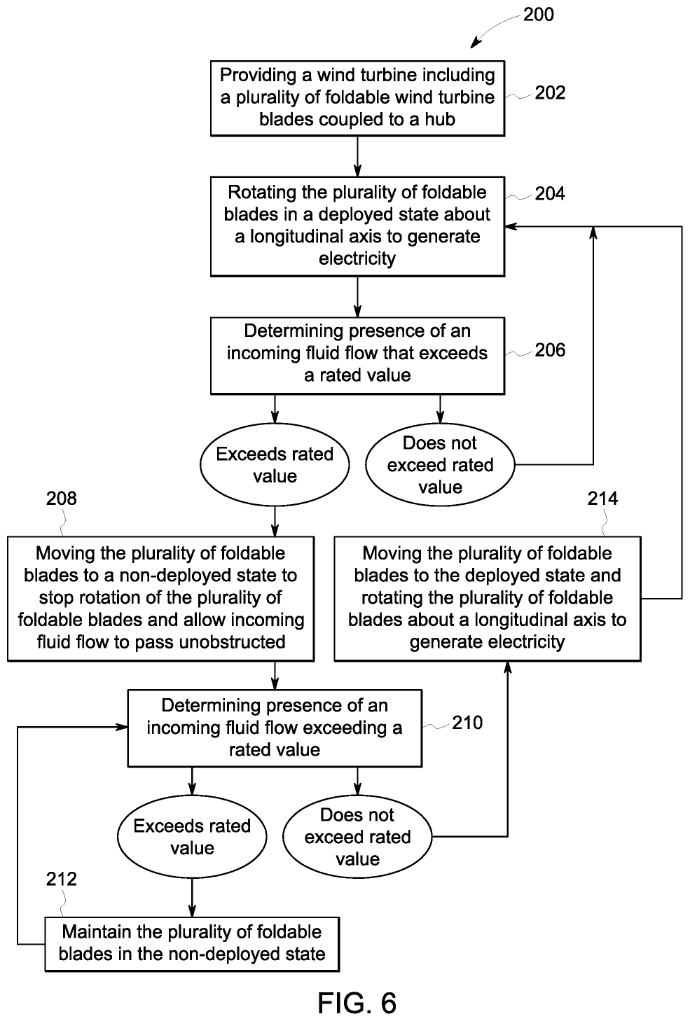

In FIG. 6 a method of using a wind turbine to improve the efficiency of the wind turbine is shown at 200. In a first step 202, a wind turbine is provided. The wind turbine includes a hub and a plurality of foldable rotor blades connected to the hub. The plurality of foldable rotor blades are rotatable about a horizontal rotor axis, in a step 204, to generate energy. Each foldable rotor blades includes a single fixed rotation point at a blade root. The plurality of foldable rotor blades may be similar to the plurality of foldable rotor blades described above. The wind turbine is operated by rotating the plurality of foldable rotor blades about the longitudinal rotor axis to generate energy.

In a step 206, a determination is made whether incoming fluid flow exceeds a rated value. If the incoming fluid flow (wind) does not exceed the rated value, the plurality of foldable rotor blades are allowed to continue to operate in the deployed state, as in step 204. If the incoming fluid flow exceeds the rated value, a mechanical actuation structure coupled to the plurality of foldable rotor blades is actuated, in a step 208, to move the plurality of foldable rotor blades to a non-deployed state, substantially parallel to the horizontal rotor axis. By positioning the plurality of foldable rotor blades substantially horizontal to the rotor axis, the incoming fluid flow that exceeds the rated value are allowed flow downstream, unobstructed, about the plurality of foldable rotor blades. Next, in a step 210, the incoming fluid flow is continually monitored, in a step 210, to determine if they exceed the rated value. If it is determined the incoming fluid flow continues to exceed the rated value, the foldable rotor blades are maintained in a non-deployed state, in a step 212, until such time the incoming fluid flow is determined in step 210, to not exceed the rated value. If it is determined in step 210 that the incoming fluid flow does not exceed the rated value, the mechanical actuation structure is actuated, in a step 214, to move the plurality of foldable rotor blades to the deployed state, substantially perpendicular to the horizontal rotor axis, and operated as in step 204. The foldable rotor blades are maintained in the deployed state until such time the incoming fluid flow is determined, in step 206, to exceed the rated value.

Accordingly, disclosed is a plurality of foldable rotor blades for enhanced performance of a wind turbine. The plurality of foldable rotor blades are caused to retract, or move to a non-deployed state upon actuation of a mechanical actuation structure, in the presence of an incoming fluid flow that exceeds the rated value for the blade design. The plurality of foldable rotor blades are caused to move to a deployed state upon actuation of a mechanical actuation structure, in the presence of an incoming fluid flow that does not exceed the rated value for the blade design.

The plurality of foldable rotor blades may be fabricated of any suitable material including, but not limited to stretchable fabric, tensionable fabric, plastic, metal, carbon fiber and/or other construction material. In an embodiment of the plurality of foldable rotor blades, including an underlying support structure where included, the structure may be fabricated of any suitable material, including, but not limited to carbon fiber and/or other material capable of lending support to the plurality of foldable rotor blades.

It will be understood that the previous apparatus configurations and modes of operation described herein are merely examples of proposed apparatus configurations and operating conditions. What is significant is the apparatus provides for enhanced performance and thus increased efficiency of a wind turbine.

The foregoing has described an apparatus and method of performance enhancement of a wind turbine. While the present disclosure has been described with respect to a limited number of embodiments, those skilled in the art, having benefit of this disclosure, will appreciate that other embodiments may be devised which do not depart from the scope of the disclosure as described herein. While the present disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out the disclosure. It is, therefore, to be understood that the appended claims are intended to cover all such modifications and changes as fall within the true spirit of the disclosure.

1. A wind turbine configured for extracting energy from a fluid flow, the wind turbine comprising a rotor, the rotor comprising:
a rotatable hub;
a plurality of foldable rotor blades coupled to the hub and rotatable about a horizontal rotor axis, where each of the plurality of foldable rotor blades has a single fixed rotation point at a blade root; and
a mechanical actuation structure coupled to the plurality of foldable rotor blades, wherein the mechanical actuation structure moves the plurality of foldable rotor blades between a deployed state and a non-deployed state in response to an incoming fluid flow, the mechanical actuation structure comprising:
a plurality of toothed wheels, each of the plurality of foldable rotor blades coupled to one of the plurality of toothed wheels at the single fixed rotation point,
a threaded rod disposed in cooperative engagement with each of the plurality of toothed wheels; and
a spring disposed proximate the threaded rod and configured to compensate for a static wind load on each of the plurality of foldable rotor blades.

2. The wind turbine as claimed in claim 1, wherein the deployed state positions the plurality of foldable rotor blades substantially perpendicular to the horizontal rotor axis, to capture kinetic energy from an incoming fluid flow that is within a rated value.

3. The wind turbine as claimed in claim 1, wherein the non-deployed state positions the plurality of foldable rotor blades substantially parallel to the horizontal rotor axis, to allow an incoming fluid flow that exceeds a rated value to flow downstream about the plurality of foldable rotor blades

4. The wind turbine as claimed in claim 1, wherein each of the plurality of toothed wheels rotate in response to an incoming fluid flow that exceeds a rated value.

5. The wind turbine as claimed in claim 4, wherein rotation of each of the plurality of toothed wheels moves a respective foldable rotor blade of the plurality of foldable rotor blades between the non-deployed state, substantially parallel to the horizontal rotor hub axis and deployed state, substantially perpendicular to the horizontal rotor hub axis.

6. The wind turbine as claimed in claim 4, wherein rotation of each of the plurality of toothed wheels applies a force on the threaded rod in a direction opposed to the incoming fluid flow and compression of the spring by the threaded rod.

7. The wind turbine as claimed in claim 1, wherein a tension of the spring is selected such that when a speed of the incoming fluid flow reaches a rated value, the spring travels a distance equal to one-quarter of a circumference of each of the plurality of toothed wheels to move each of the plurality of foldable rotor blades to the non-deployed state.

8. The wind turbine as claimed in claim 1, wherein the plurality of foldable rotor blades simultaneously move an equal distance.

9. The wind turbine as claimed in claim 1, wherein the plurality of foldable rotor blades comprise three foldable rotor blades equally spaced about the rotor hub.

10. The wind turbine as claimed in claim 1, wherein the plurality of foldable rotor blades comprise two foldable rotor blades equally spaced about the rotor hub.

11. A wind turbine configured for extracting energy from a fluid flow, the wind turbine comprising a rotor, the rotor comprising:
a rotatable hub;
a plurality of foldable rotor blades coupled to the hub and rotatable about a horizontal rotor axis, where each of the plurality of foldable rotor blades has a single fixed rotation point at a blade root; and
a mechanical actuation structure coupled to the plurality of foldable rotor blades, wherein the mechanical actuation structure moves the plurality of foldable rotor blades to a deployed state, substantially perpendicular to the horizontal rotor axis, to capture kinetic energy from an incoming fluid flow and moves the plurality of foldable rotor blades to a non-deployed state, substantially parallel to the horizontal rotor axis, the mechanical actuation structure comprising:
a plurality of toothed wheels, each of the plurality of foldable rotor blades coupled to one of the plurality of toothed wheels at the single fixed rotation point and rotatable in response to an incoming fluid flow,
a threaded rod disposed in cooperative engagement with each of the plurality of toothed wheels; and
a spring disposed proximate the threaded rod and configured to compensate for the static wind load on each of the plurality of foldable rotor blades,
wherein rotation of each of the plurality of toothed wheels applies a force on the threaded rod in a direction opposed to the incoming fluid flow and compression of the spring by the threaded rod.

12. The wind turbine as claimed in claim 11, wherein rotation of each of the plurality of toothed wheels moves a respective foldable rotor blade of the plurality of foldable rotor blades between the non-deployed state, substantially parallel to the horizontal rotor hub axis and deployed state, substantially perpendicular to the horizontal rotor hub axis.

13. The wind turbine as claimed in claim 11, wherein a tension of the spring is selected such that when a speed of the incoming fluid flow reaches a rated value the spring travels a distance equal to one-quarter of a circumference of each of the plurality of toothed wheels to move each of the plurality of foldable rotor blades to the non-deployed state.

14. A method of using of a wind turbine comprising:
providing a wind turbine including a hub and a plurality of foldable rotor blades coupled to the hub and rotatable about a horizontal rotor axis, where each of the plurality of foldable rotor blades has a single fixed rotation point at a blade root;
rotating the at least one rotor blade about the horizontal rotor axis to generate energy;
determining if incoming fluid flow exceeds a rated value;
actuating a mechanical actuation structure coupled to each of the plurality of foldable rotor blades in the presence of an incoming fluid flow that exceeds the rated value to move the plurality of foldable rotor blades to a non-deployed state, substantially parallel to the horizontal rotor axis;
determining if the incoming fluid flow exceeds the rated value;
actuating the mechanical actuation structure in the presence of an incoming fluid flow that does not exceed the rated value to move the plurality of foldable rotor blades to a deployed state, substantially perpendicular to the horizontal rotor axis, to capture kinetic energy from the incoming fluid flow that is within the rated value,
wherein the mechanical actuation structure comprises:
a plurality of toothed wheels, each of the plurality of foldable rotor blades coupled to one of the plurality of toothed wheels at the single fixed rotation point,
a threaded rod disposed in cooperative engagement with each of the plurality of toothed wheels; and
a spring disposed proximate the threaded rod and configured to compensate for a static wind load on each of the plurality of foldable rotor blades.

15. The method as claimed in claim 14, wherein each of the plurality of toothed wheels rotate in response to the incoming fluid flow that exceeds the rated value.

16. The method as claimed in claim 15, wherein rotation of each of the plurality of toothed wheels moves a respective foldable rotor blade of the plurality of foldable rotor blades between the non-deployed state, substantially parallel to the horizontal rotor hub axis and deployed state, substantially perpendicular to the horizontal rotor hub axis.

17. The method as claimed in claim 15, wherein rotation of each of the plurality of toothed wheels applies a force on the threaded rod in a direction opposed to the incoming fluid flow and compression of the spring by the threaded rod.

18. The method as claimed in claim 14, wherein a tension of the spring is selected such that when a speed of the incoming fluid flow exceeds the rated value the spring travels a distance equal to one-quarter of a circumference of each of the plurality of toothed wheels to move each of the plurality of foldable rotor blades to the non-deployed state.

19. The method as claimed in claim 14, wherein the plurality of foldable rotor blades simultaneously move an equal distance in response to the speed of the incoming fluid flow.

20. The method as claimed in claim 14, wherein the plurality of foldable rotor blades comprise three foldable rotor blades equally spaced about the rotor hub.

21. The method as claimed in claim 14, wherein the wind turbine is a downstream, horizontally oriented wind turbine.
